(19) United States
(12) Patent Application Publication
(10) Pub. No.: US 2007/0065785 A1
(43) Pub. Date: Mar. 22, 2007

(54) Device for representing the lung, the volume of the lung, and respiration characteristics of the lung, and the use thereof

(75) Inventor: Harald Wenske, Mainz (DE)

Correspondence Address: MICHAEL P. MORRIS;BOEHRINGER INGELHEIM CORPORATION, 900 RIDGEBURY ROAD, P. O. BOX 368, RIDGEFIELD, CT, 06877-0368, US

(73) Assignee: Boehringer Ingelheim International GmbH, Ingelheim (DE)

(21) Appl. No.: 10/556,746

(22) PCT Filed: Apr. 6, 2004
(86) PCT No.: PCT/EP04/03622

§ 371 Date: Oct. 16, 2006

(30) Foreign Application Priority Data
May 16, 2003 (DE) 103 22 180.8

(51) Int. Cl. G09B 11/00

(52) U.S. Cl. 434/86

(57) ABSTRACT

The invention relates to a device for representing the lung, the volume of the lung, and the respiration characteristics of the lung, comprising a Y-shaped tube containing a main tube (10) which branches into a first branch (20) and a second branch (30), whereby one branch (20,30) is provided with an obstruction (50). A device for collecting and/or determining an amount of gas (100) introduced therein is disposed at the end of the two branches (20,30). The invention also relates to the use of the above-mentioned device which can act as a model in patients suffering from obstructive respiratory tract diseases. The inventive device provides an easy-to-use model for the representation of the functions of the lung, particularly in the case of restrictions such as COPD.

### BACKGROUND OF THE INVENTION

1. Field of the Invention

The present invention relates to a device for representing the lung, the volume of the lung, and the respiration characteristics of the lung, and the use thereof and is used to illustrate obstructive disease of the airways.

2. Description of the Prior Art

There are a great many different methods connected with the representation of diffuse lung and/or respiratory tract diseases, in which attempts are made to obtain an original image of the lungs and respiratory tract using highly complex equipment, e.g., computer tomography with special contrast agents (cf., DE 101 07 765A1). In many cases, complicated techniques are unavoidable.

The objective in medical research is therefore always to discover methods which are as simple and non-invasive as possible for obtaining better insights into normal or disrupted processes/conditions of the human body.

Thus, U.S. Pat. No. 3,874,093 and U.S. Pat. No. 6,296,490 describe the precise anatomical models by which the respiration characteristics of a healthy human being can be learned and investigated. Corresponding pathological conditions such as restrictions cannot be represented, nor are they intended to be.

Moreover, U.S. Pat. No. 5,823,787 describes a mechanical model for demonstrating the system of the respiratory tract in normal and pathological conditions. In particular, FIG. 1 shows an airway with two bronchial branches each provided at their distal end with an inflatable lung sac. Each of the two bronchial branches may have a restriction which is provided, for example, in the form of an inflatable bladder or sleeve. In this way restriction of volume can be represented to a variable degree, as well as total blockage or occlusion of the respiratory tract.

In fact, this model provides a very complex and almost impossibly complicated representation of the entire respiration system with all the anatomical details, including the oesophagus and the stomach. The restrictions can indeed be variably adjusted but have to be operated using special operating elements by a trained person. The method of producing a restriction also requires a flexible compressible material such as rubber, so that it appears that the model can only be handled in a fixedly mounted position, for example on a frame or stand or in an anatomical doll.

### SUMMARY OF THE INVENTION

Consequently, the aim of the invention is to produce a device which provides an easily operated demonstration model for representing the mode of operation of the lungs in pathological conditions such as restrictions, particularly obstructive respiratory complaints. Moreover, it should be possible to represent the lung or lung volume without great expenditure on apparatus, illustrating the bilateral lung capacity and respiration characteristics in various pathological conditions by simple means.

### BRIEF DESCRIPTION OF THE DRAWINGS

FIG. 1 shows of a device according to the present invention.

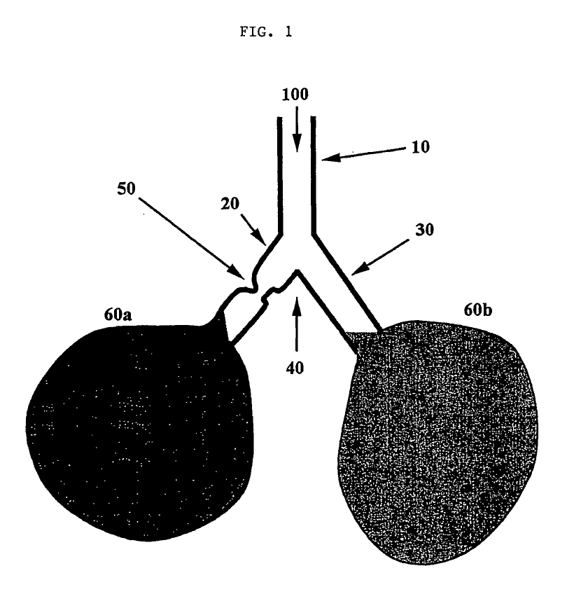

### DETAILED DESCRIPTION OF THE INVENTION

According to the invention, the problem described above is solved by a device for representing the lungs, the volume of the lungs, and the respiratory characteristics of the lungs, which device comprises: a Y-shaped tube containing a main tube (10) which branches into a first branch (20) and a second branch (30), one branch (20,30) of which has an obstruction, while at the end of each branch (20,30) is provided a device for collecting and/or determining an amount of gas introduced.

The length of the two branches (20,30) is not critical per se. Expediently, the two branches (20,30) are the same length.

According to the invention, the obstruction may be located anywhere along the entire length of one of the two branches. Preferably, however, the obstruction is provided in the middle of one of the two branches. Expediently, the obstruction is a constriction in the form of a narrowing of one branch, which may be symmetrical or asymmetrical and has a defined, fixed (i.e., invariable) size. By an asymmetrical obstruction in a branch is meant, according to the invention, a depression, for example. A symmetrical formation represents a reduction in the diameter of the tube, for example. Varying the obstruction makes it possible to detect different degrees of severity in pathological conditions and reproduce their effects as accurately as possible.

Appropriately, the diameter of the tube at the obstruction is selected so that the pathological condition to be represented can be illustrated. For example, the diameter of the tube may be reduced in size by about half at the obstruction, compared with the normal tube diameter in the device according to the invention. It goes without saying that too great an obstruction causes blockage of one branch, so that the gas introduced cannot pass through. On the other hand, if the narrowing of the tube diameter is too little, an inadequate effect may again be obtained, so that the expiratory and inspiratory flow limitation is no longer clearly represented. However, the skilled man familiar with the prior art will have no difficulty in providing a suitably formed obstruction at a desired location in one branch in order to achieve optimum results, i.e. to obtain a representation which is as similar as possible to the pathological condition to be illustrated, clearly demonstrating the effects thereof.

One model can be used to illustrate a degree of severity of the obstruction. If a plurality of models with different obstructions are produced and used, the effects as a whole ranging from slight to moderately severe to severe obstructions can be demonstrated.

Preferably, the internal diameter of the obstruction point is about 10 to 90%, more particularly 30 to 70%, most preferably about 50% of the internal diameter of the two branches.

The device according to the invention may consist of glass, plastics, metal or wood or may contain these materials. According to a particularly preferred embodiment of the invention it is made of glass or plastics, as this makes it easier to manufacture. Preferably, the apparatus is translucent or totally transparent.

It may be advantageous in the device according to the invention if the main tube has an optionally removable mouthpiece for respiratory air to be blown in. However, this is not necessary in every case as a conventional tube opening can also perform the function. The device according to the invention may be filled with any desired gas, e.g. through a hose or flexible tube, the obvious choices being ambient air, respiratory air or nitrogen, for reasons of cost.

To represent the lungs, the volume of the lungs and the respiratory characteristics, in the device according to the invention means for collecting and/or determining the amount of gas or air introduced are provided at the ends of the two branches in the device according to the invention. In the simplest case they may be balloons, for example. For better attachment and securing of these devices, such as balloons, it is particularly expedient if the two branches have a thickened portion in the form of a bead at their ends. This prevents the balloons from slipping off or becoming detached.

By choosing balloons of different size and/or elasticity on the two branches it is possible to deliberately produce different representations. According to another embodiment it is also possible to close off the main tube so that the representation of the lung/lung capacity can be considered and analysed in more detail and the introduction and expulsion of the gas, corresponding to breathing in and breathing out, can be demonstrated in individual steps using the device according to the invention.

By introducing a defined quantity of gas it is possible to deliberately simulate different situations of inspiration and expiration.

The invention also relates to the use of the device according to the invention for representing the lungs, the volume of the lungs and the respiratory characteristics, particularly in cases of obstructive respiratory disease. The obstructive respiratory diseases may be, for example, asthma, parenchymal disease or COPD.

The device according to the invention for representing the lungs, the volume of the lungs and the respiratory characteristics is used as follows: A gas such as respiratory air is introduced, optionally through a mouthpiece, into the main tube of the device according to the invention, the main tube optionally being first closed off and then opened, and then the gas introduced is released.

The device according to the invention is therefore particularly suitable for representing the lungs/lung volume in patients suffering from obstructive respiratory disease. This is an all-embracing name for (chronic) diseases of the bronchopulmonary system with obstructive ventilation disorders. One acute reversible obstructive respiratory complaint is asthma, for example. Other obstructive respiratory diseases are COAD (Chronic Obstructive Airways Disease) or COPD (Chronic Obstructive Pulmonary Disease), such as for example chronic bronchitis or emphysematous changes to the lungs as a result of chronic bronchitis, which may lead to the destruction of alveoli and the septa of the lungs (pulmonary emphysema).

Symptoms of obstructive pulmonary diseases of this kind are respiratory distress, usually only under stress, restricted respiratory breadth, defined as a reduced difference in the circumference of the thorax between the maximum inspiration and expiration, greatly increased breath sounds and the like. Expansion and atrophy of the lung tissue, reduced lung expansion and capacity and increasing (chronic) breathing insufficiency, particularly in old age, also play a part.

Diseases of this kind may be addressed not only by conventional medical diagnosis and treatment but also by a supplementary therapy in the form of breathing exercises and breath training. The device according to the invention is useful in this context for explaining the necessary therapy to the patient as it is easy to demonstrate the obstructive respiratory disease. The device may be regarded as a simplified representation of the patient's lungs. The main tube symbolises the windpipe and the two branches represent the main bronchi which lead into the lungs, which may be represented by two balloons.

The device according to the invention thus serves as a kind of model, representing the lungs/lung capacity of the patient after respiratory air, for example, has been blown into the device.

The detailed mode of operation of the device according to the invention will now be described with reference to the attached Figure, although this should not restrict the invention.

The Figure shows a device according to the invention in the form of an “obstructive lung model” in the shape of an inverted letter Y. The present Figure shows a system of glass tubes made up of a main tube 10 which branches into two branches 20 and 30. The diameter of the glass tube both in the main tube 10 and in the branches 20,30 is 20 mm. The main tube 10 has a length of 120 mm up to the branching point 40 and corresponds to the windpipe. The main tube 10 may be fitted with an optionally removable mouthpiece (not shown) which makes it easier to blow respiratory air 100 in. A closure cap may be fitted to this mouthpiece so as to produce a closed system immediately after the respiratory air 100 has been blown in.

The length of the two branches 20 and 30 is 80 mm in the embodiment of the invention shown here. The first branch 20 has a constriction (obstruction) 50 with a diameter of 8 mm. 25 mm from the end of the branch is provided a thickened portion (not shown) in the form of a bead, to prevent the attached device (or devices) from becoming detached or slipping off.

The devices for collecting and/or determining the air 100 are two balloons 60a and 60b, in the Figure shown, which are pulled over the ends of the two branches 20 and 30 and correspond to the lungs. During inspiration, the two balloons 60a and 60b fill up, thus providing a simplified model of the lungs. The size of the filled balloons 60a and 60b enables conclusions to be drawn as to the amount of air 100 introduced and, if suitably calibrated, will even allow the amount to be measured, and will facilitate the representation of certain pathological conditions.

This model according to the invention is used to illustrate the medical term “obstructive airflow limitation.” This term is of central importance in patients with obstructive respiratory diseases such as asthma and COPD. In this way, by improving the patients' understanding of their disease as illustrated to them by the model according to the invention, it is possible to give the patient easier access to the possible treatments.

With this model, which is made available according to the invention, the effects of obstruction on the mechanics of inspiration and expiration can be illustrated and explained, for example, in relation to two balloons. In addition, using two different balloons (different elasticity-size-capacity) the influence of different restoring forces in parenchymal diseases (emphysema) can be illustrated and explained. With this model according to the invention in conjunction with balloons the expression “obstructive flow limitation in respiratory diseases” (expiratory airflow limitation) can be illustrated and brought home to the patient.

The object of the invention gives rise to a further number of advantages by virtue of its very simplicity:

The device according to the invention constitutes only a small part of the respiratory system, which an affected patient is able to hold for themselves and view from all sides without becoming confused and deflected from the essential symptoms of the disease by an apparatus overloaded with details, which is intended rather for a medically trained person.

The obstruction according to the invention is not variable but is present in a defined selected size, and is provided for example in the form of a depression or constriction in the model, while a number of models with different constrictions may be used to illustrate different respiratory complaints, so that the patient can concentrate only on the model which applies particularly to his disease, with a fixed restriction of a specific size.

The use of the device, i.e. the displaying of the respiratory characteristics, according to the invention is also much simpler compared with the prior art described previously, as respiratory air is blown into the device using a mouthpiece, for example, and then by closing and opening the main tube it is possible to view the processes in “slow motion”.

Moreover, the demonstration model in the present invention is also greatly superior to the prior art in terms of handling qualities as the model is made of a rigid or virtually inflexible material, which means that there is no need for any additional fixing means and the model on its own can be handled, rotated and viewed in operation from all sides.

The clear simplification of the model, together with easier operation, makes it possible for any sick patient to gain easy insight into his illness so as to make continuing treatment for the disease easier on the basis of his understanding.

### EXAMPLES

To illustrate the method of operation of the device according to the invention the embodiment according to the invention shown in the Figure was tested in a number of tests:

### Example 1

Identical Elasticity in Both Balloons

(Obstruction Only, No Loss of Elasticity in the Bronchi):

The balloon on the branch without obstruction, corresponding to an open bronchus, fills up first.

When the balloons are inflated identically, the balloon on the constricted branch empties more slowly.

### Example 2

Balloons with Different Elasticity

(Obstruction and Loss of Elasticity in One Bronchial Area):

The balloon with lower elasticity empties even more slowly at the constricted branch.

### Example 3

Breath Sounds

(Typical of Patients with Moderately Severe Chronic Obstructive Pulmonary Diseases)

When the balloon on the constricted branch is inflated a “whistling” sound is heard.

The device according to the invention thus serves as a simple model for representing the lungs, the volume of the lungs and the different respiratory characteristics in patients with obstructive respiratory disease.

1. A device for representing the lungs, the volume of the lungs, and the respiratory characteristics of the lungs, the device comprising:
a Y-shaped tube comprising a main tube (10), a first branch (20) connected to a device (60a) for collecting or determining an amount of gas from the first branch (20), and a second branch (30) connected to a device (60b) for collecting or determining an amount of gas from the second branch (30), and an obstruction (50) disposed in one of the branches (20,30), whereby the lungs, the volume of the lungs, and the respiratory characteristics of the lungs are represented to a user of the device.

2. The device according to claim 1, wherein the obstruction (50) is disposed in the middle of one of the branches (20,30).

3. The device according to claim 1, wherein the two branches (20,30) are substantially the same length.

4. The device according to claim 1, wherein the obstruction (50) is of symmetrical construction.

5. The device according to claim 1, wherein the obstruction (50) comprises a depression.

6. The device according to claim 1, wherein the obstruction (50) reduces the diameter of the tube.

7-8. (canceled)

9. The device according to claim 1, wherein the main tube (10) comprises a removable mouthpiece.

10. The device according to claim 1, wherein the main tube (10) can be closed off.

11. The device according to claim 1, wherein the devices (60a, 60b) adapted to collect or determine an amount of gas from the first and second branches (20,30) each comprise a balloon.

12. The device according to claim 11, wherein the balloons (60a, 60b) are of different sizes or elasticity.

13. (canceled)

14. A method to represent the lungs, the volume of the lungs, and the respiratory characteristics of the lungs in obstructive respiratory diseases, the method comprising:
providing a device for representing the lungs, the volume of the lungs, and the respiratory characteristics of the lungs, the device comprising:
a Y-shaped tube comprising a main tube (10), a first branch (20) connected to a device (60a) for collecting or determining an amount of gas from the first branch (20), and a second branch (30) connected to a device (60b) for collecting or determining an amount of gas from the second branch (30), and an obstruction (50) disposed in one of the branches (20,30).

15. The method of claim 14, wherein the obstructive respiratory diseases are asthma, parenchymal disease, or COPD.

16. The device according to claim 1, wherein the obstruction (50) is asymmetrical.

17. The device according to claim 1, wherein the devices (60a, 60b) adapted to collect or determine an amount of gas from the first and second branches (20,30) are suitably calibrated, whereby an amount of gas from the first or second branches (20,30) is measurable.
